(19) United States
(12) Patent Application Publication
(10) Pub. No.: US 2009/0108533 A1
(43) Pub. Date: Apr. 30, 2009

(54) ROTATION SHAFT SEAL

(75) Inventors: Tetsuya ASHIDA, Hyogo (JP); Hironori Oida, Wakayama (JP)

Correspondence Address: KRATZ, QUINTOS & HANSON, LLP, 1420 K Street, N.W., Suite 400, WASHINGTON, DC, 20005, US

(73) Assignee: MITSUBISHI CABLE INDUSTRIES, LTD., Tokyo (JP)

(21) Appl. No.: 12/209,373

(22) Filed: Sep. 12, 2008

(30) Foreign Application Priority Data
Oct. 25, 2007 (JP) 2007-277271

(51) Int. Cl. F16J 15/34

(52) U.S. Cl. 277/399

(57) ABSTRACT

A rotation shaft seal in which a plate-shaped supporting piece, supporting a seal element from a low-pressure side, has an axis-orthogonal wall portion, a sloped wall portion, and an inner peripheral end flat wall portion at right angles with an axis in cross section cut at a plane including the axis of the rotation shaft.

### BACKGROUND OF THE INVENTION

1. Field of the Invention

This invention relates to a rotation shaft seal.

2. Description of the Related Art

Conventionally, a rotation shaft seal having a seal element 31 composed of PTFE as shown in FIGS. 6A and 6B is known. And, another rotation shaft seal, having a similar seal element disclosed by Japanese patent provisional publication No. 2003-194231, is known.

In these rotation shaft seals, great abnormal abrasion may be generated locally in a curved portion 33 when sealed fluid (including gas) has high pressure, or when surrounding portions (especially a sliding face 32) has high temperature and strength of the seal element 31 is reduced. Further, when pressure P in a sealed fluid chamber 34 is high, the curved portion 33 (in a normal state of FIG. 6A) generates deformation 40 locally (and excessively) as shown in FIG. 6B for insufficient strength of the seal element 31, the curved portion 33 deviates from a gap portion 38 between an inner peripheral end edge portion 36 of a plate-shaped supporting piece 35 such as an outer case and a rotation shaft 37, and the original configuration (refer to FIG. 6A) of the curved portion 33 can not be maintained thereby. It is difficult to keep stable sealing ability for a long period of time with these local abrasion and deviation.

To solve these problems, a rotation shaft seal as shown in FIG. 7 is conventionally proposed (a similar seal is disclosed by FIG. 6 of Japanese patent provisional publication No. 2005-201336).

In the conventional rotation shaft seal of FIG. 7, an outer case (plate-shaped supporting piece) 35 is composed as that an inner peripheral edge 39 has a sloped wall portion 41 approaching a rotation shaft 37 with inclination toward the high-pressure side (the sealed fluid chamber 34 side) to support the curved portion 33 of the seal element 31 from the low-pressure side as to prevent the local deformation in FIG. 6B.

However, it is necessary to secure a certain clearance 42 between an inner peripheral face 36A of the sloped wall portion 41 and the rotation shaft 31 for assembly process, and the sloped wall portion 41 has a sharp end portion 43 on the high-pressure side.

Therefore, when high pressure is loaded, the curved portion 33 may deviate from the clearance 42, the sharp end portion 43 may damage the curved portion 337 and working life of the seal may be shortened by generation of abraded powder.

It is therefore an object of the present invention to provide a rotation shaft seal, solving the above-described various conventional problems, with which the curved portion does not generate abnormal local deformation, abrasion, and damage even if high pressure of fluid (gas) works on the seal element composed of PTFE, and excellent sealability is shown for a long period of time.

### BRIEF DESCRIPTION OF THE DRAWINGS

The present invention will be described with reference to the accompanying drawings in which:

FIG. 1 is a cross-sectional view of a principal portion showing an embodiment of the present invention;

FIG. 2 is an enlarged cross-sectional explanatory view of a principal portion;

FIG. 3A is an explanatory view of function of the present invention;

FIG. 38 is an explanatory view of function of a conventional example;

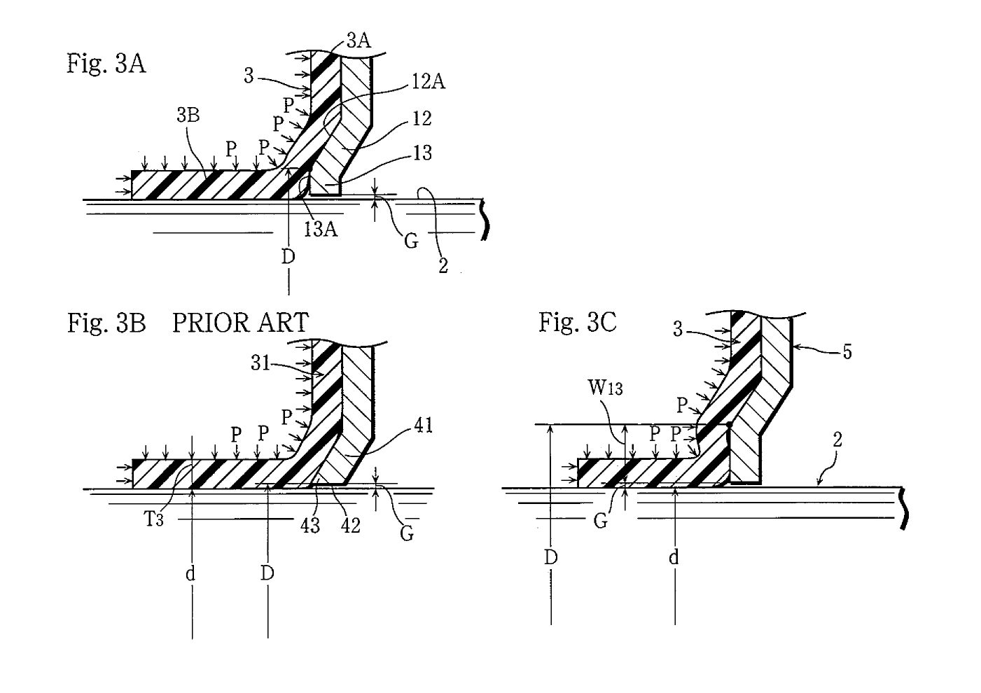

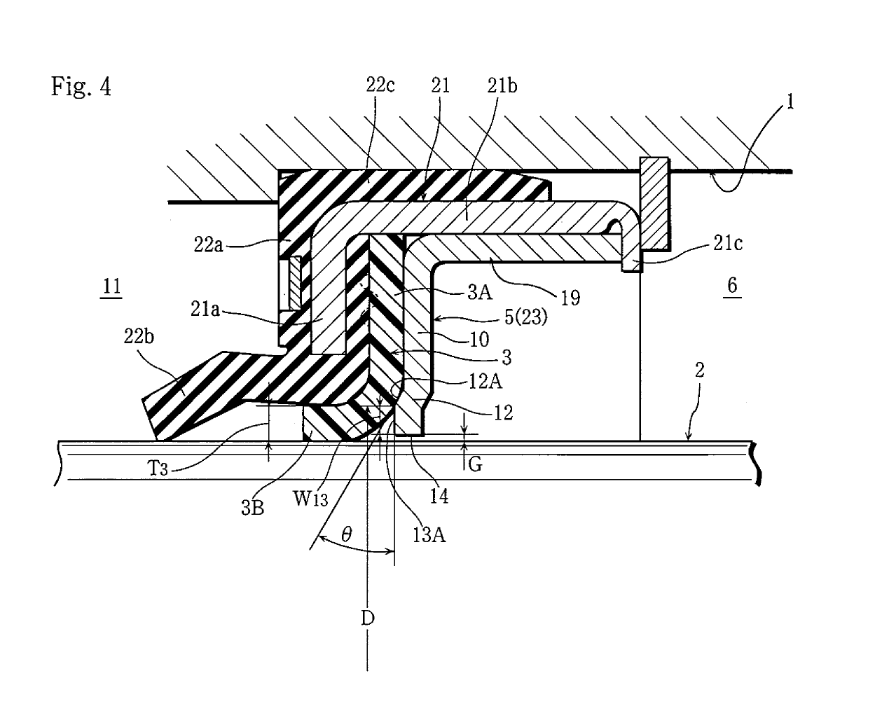

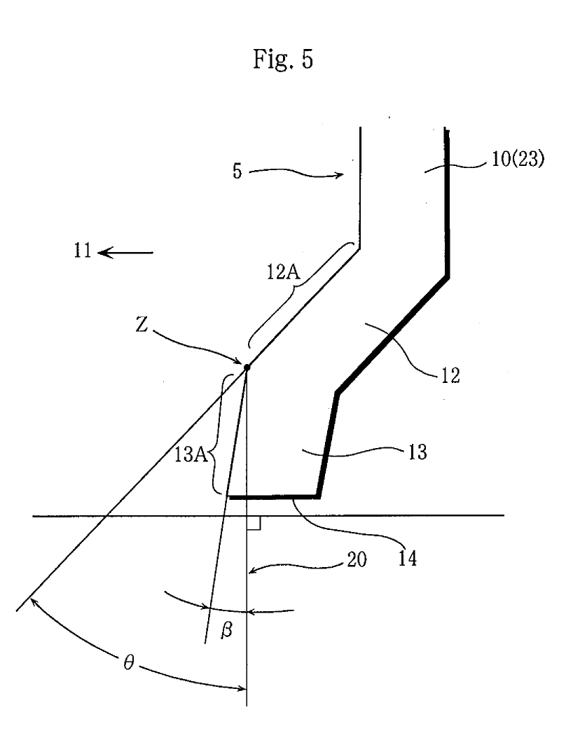

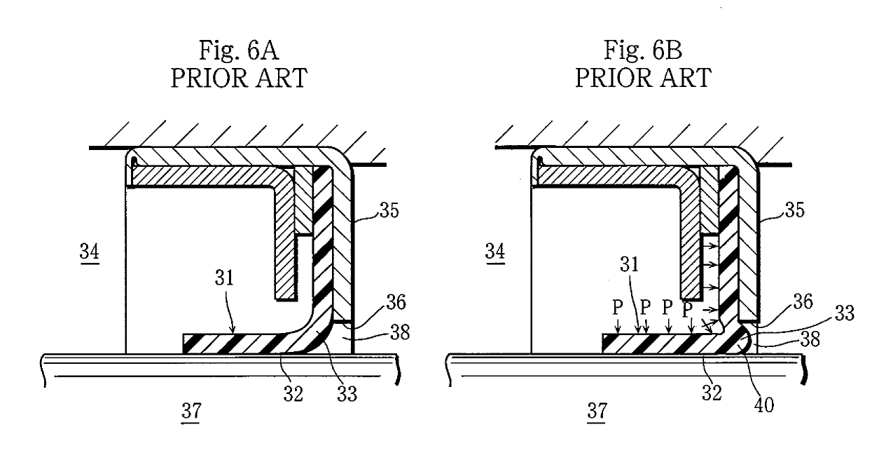

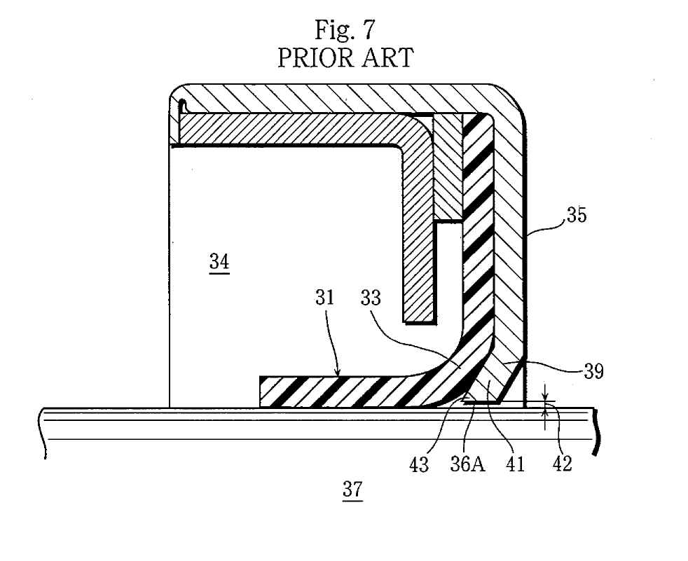

FIG. 3C is an explanatory view of function of a comparison example;

FIG. 4 is an enlarged cross-sectional view of a principal portion showing another embodiment;

FIG. 5 is an enlarged cross-sectional view of a principal portion;

FIG. 6A is a cross-sectional view showing a conventional example;

FIG. 6B is a cross-sectional view showing the conventional example; and

FIG. 7 is an enlarged cross-sectional view showing another conventional example.

### DESCRIPTION OF THE PREFERRED EMBODIMENTS

Preferred embodiments of the present invention will now be described with reference to the accompanying drawings.

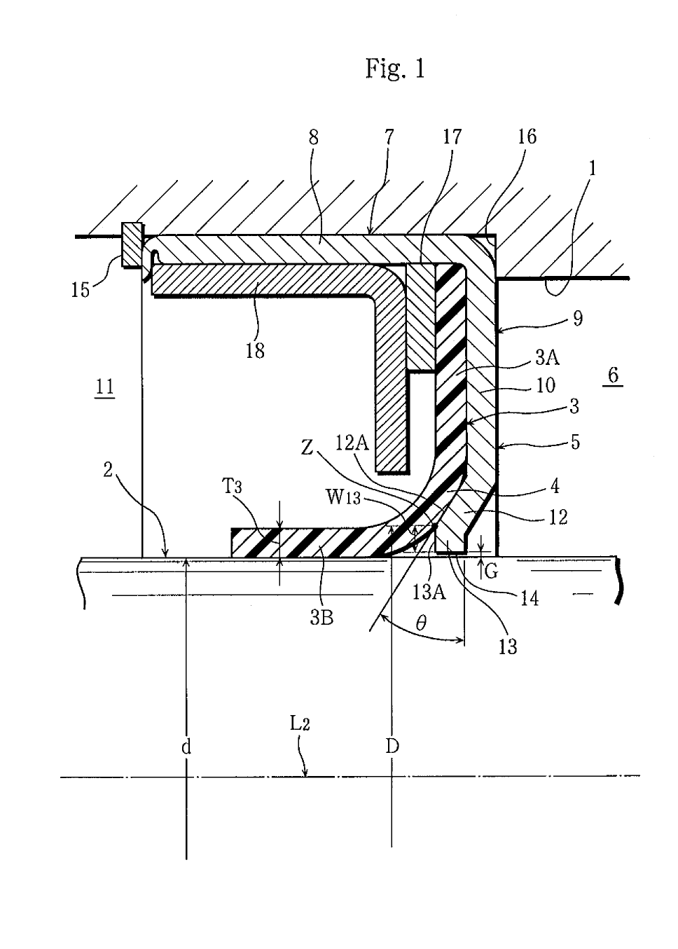

FIGS. 1, 2, 3A show an embodiment of a rotation shaft seal relating to the present invention which is attached between a housing 1 and a rotation shaft 2.

A mark 3 represents a plate-shaped seal element composed of resin such as PTFE attached with a curved portion 4 as an L-shaped curve. That is to say, as shown in FIG. 1, in a cross section cut by a plane including an axis L₂ of the rotation shaft 2, the seal element 3 is L-shaped composed of an axis-orthogonal portion 3A, the curved portion 4, and a cylinder portion 3B (parallel to the axis L₂).

A mark 5 represents a plate-shaped supporting piece supporting the seal element 3 from a low-pressure side 6. The supporting piece 5 is composed of a part of an outer case 7 fit to the housing 1 in FIG. 1. That is to say, the outer case 7 is composed of a cylinder portion 8 for fitting the housing and a radial wall portion 9 at right angles with the axis, and the latter (the radial wall portion 9) composes the supporting piece 5.

The supporting piece 5 is provided with an axis-orthogonal wall portion 10, a sloped wall portion 12 of which inner peripheral side inclines toward a high-pressure side 11 for a predetermined inclination angle θ, and an inner peripheral end flat wall portion 13 at right angles with the axis serially from the outer peripheral side to the inner peripheral side.

The inner peripheral end flat wall portion 13 at right angles with the axis has a dimension W 3 in radial direction approximately equal to a thickness dimension T₃ of the seal element 3.

In the sloped wall portion 12 and the inner peripheral end flat wall portion 13, faces 12A and 13A facing (or in contact with) the seal element 3 are especially important. In the cross-sectional view shown in FIG. 1, a dimension from an intersection point Z of the sloped face 12A and the flat face 13A to an innermost peripheral end face 14 of the inner peripheral end flat wall portion 13 is the dimension W₁₃ in radial direction.

And, the innermost peripheral end face 14 is disposed near the rotation shaft 2 as to form a micro gap G between the inner peripheral end flat wall portion 13 and the rotation shaft 2.

The micro gap G is set to be 0.1 mm to 0.25 mm (on one side). When the gap G is less than the minimum value, the innermost peripheral end face 14 may contact the rotation shaft 2 in assembly process or by working tolerance. To the contrary, when the gap G is more than the maximum value, the curved portion of the seal element 3 receiving pressure may deviate from the gap C.

When the outer diameter dimension of the inner peripheral end flat wall portion 13 is D, the outer diameter dimension of the rotation shaft 2 is d, and the thickness dimension of the seal element 3 is T₃, these are set to fulfill the following formula.

d+1.2T₃≦D≦d+3.0T₃

The outer diameter dimension D of the inner peripheral end flat wall portion 13 corresponds to the diameter of the circle drawn by the intersection point Z.

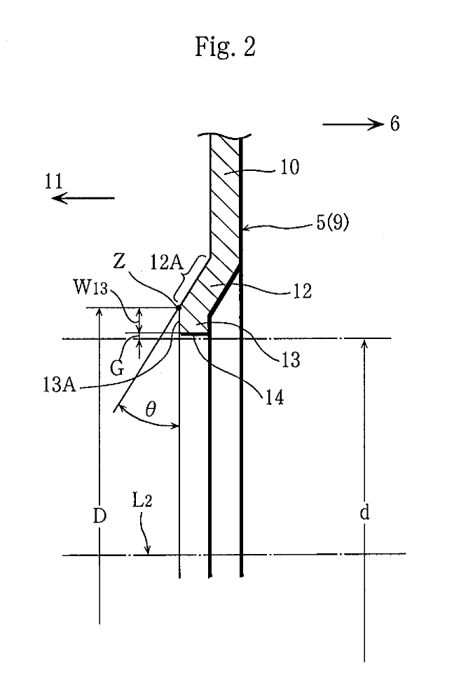

As clearly shown in FIGS. 1 and 2, D=d+2(W₁₃+G), and a relational expression 1.2≦2(W₁₃+G) 3.0T₃ is derived. So a relational expression 0.6T₃≦(W₁₃+G)≦1.5T₃ is fulfilled when 0.1 mm≦G≦0.25 mm, and it is preferable to set the position of the intersection point Z according to the relational expression.

To explain the entire schema of FIG. 1, in this rotation shaft seal, the outer case 7 is fit to a hole portion on the housing 1 and positioned along the axis direction by, for example, a staged portion 16 and a stopping ring 15.

The seal element 3, a spacer 17 of flat ring, and an inner case 18 are serially fit into the outer case 7 having an approximately L-shaped cross section, and unitedly assembled by caulking of an end side (an end portion on the high-pressure side 11) of the cylinder portion 8 of the outer case 7.

The seal element 3 is of flat ring before the rotation shaft 2 is inserted (i.e. in unattached state), and having L-shaped cross section in which the cylinder portion 3B contacts the rotation shaft 2 when the rotation shaft 2 is inserted (in attached state of FIG. 1). Although not shown in Figures, a spiral groove is formed on the contact face as to make pumping effect to push the sealed fluid back to the high-pressure side 11. The material for the seal element 3 is plastic such as PTFE.

As shown in FIG. 1, a peripheral end edge of the seal element 3 is held and fixed by the spacer 17 and the axis-orthogonal wall portion 10. And, a back face (on the low-pressure side) of the seal element 3 contacts a high-pressure side face of the axis-orthogonal wall portion 10 of the outer case 7 and the high-pressure side face 12A of the sloped wall portion 12 to be held. It is preferable to maintain a state in which the high-pressure side face 13A of the flat wall portion 13 slightly contacts the seal element under a normal pressure-receiving state shown in FIG. 3A.

And, the inclination angle θ of the sloped wall portion 12 is set to be 20° to 40° (in FIGS. 1, 2, and 5), namely, 20°≦θ≦40°.

Further, an angle β with which the inner peripheral end flat wall portion 13 becomes an axis-orthogonal face 20 (refer to FIG. 5) is set to be −5° to +5°, namely, −5°≦β≦+5°.

Being at right angles with the axis means the inner peripheral end flat wall portion 13 is within the range of the angle β. When the angle β is plus, the flat wall portion 13 inclines toward the high-pressure side 11. When β<(−5°), local abnormal deformation is generated on the back side of the seal element 3. On the contrary, when β>+5°, the problem of the end portion 43, described with the conventional example in FIG. 7, is generated.

Next, FIG. 4 shows another embodiment in which the plate-shaped supporting piece 5 may be composed of a part of an inner case 19.

In FIG. 4, an outer case 21 has a cylinder portion 21b, an inner brim portion 21a on the high-pressure side, and a caulking portion 21c. A rubber portion 22, composed of a U-shaped rubber portion 22a covering the inner brim portion 21a on the high-pressure side of the outer case 21, a rubber lip portion 22b extending to the high-pressure side 11 and sliding on the rotation shaft 2, and a periphery-covering rubber layer portion 22c fit to the inner peripheral face of the housing 1, is unitedly fixed to the outer case 21 with adhesive.

The seal element 3 is held by the inner brim portion 21a of the outer case 21 and an axis-orthogonal wall portion 23 of the inner case 19 with a part of the U-shaped rubber portion 22a.

The axis-orthogonal wall portion 23 of the inner case 19 is corresponding to the plate-shaped supporting piece 5.

The composition of configuration and dimension of the plate-shaped supporting piece 5 in the embodiment shown in FIG. 4 is not explained because it is similarly composed as in the embodiment described with FIGS. 1, 2, and 5 (same marks represent same members).

Next, function (effect) of the main composition of the present invention is explained with FIGS. 3A through 3C. FIG. 3A shows a pressure-receiving state in the embodiment of the present invention in former-described FIGS. 1 and 2 (or FIG. 4). The seal element 3 moderately deforms when receiving pressure P, and deformation and damage are not generated. That is to say, the seal element 3 is certainly received by the high-pressure side face 12A of the sloped wall portion 12, and the high-pressure side face 13A of the flat wall portion 13 near the rotation shaft 2 receives with light contact (low contact pressure). So abnormal local deformation is prevented and damage is not caused.

However, FIG. 3B shows a case in which the flat wall portion 13 in FIG. 3A does not exist as expressed by D=d+2G corresponding to the conventional example of FIG. 7. The seal has short life because the seal element 31 may be damaged by the sharp end portion 43 of the sloped wall portion 41 and deviation may be generated on the clearance 42 in the pressure-receiving state in which the pressure P works. This is a problem generated in a case of D<d+1.2T₃.

And, as shown in FIG. 3C, in case of D>d+3.0T₃, the seal element 3 is bent (flexed) at several portions. This causes deformation and camber, and local abnormal heating and abrasion are generated thereby.

Therefore, in comparison of FIG. 3A with FIGS. 3B and 3C, it is important to fulfill the formulas d+1.2T₃≦D≦d+3.0T₃ and 0.1 mm≦G≦0.25 mm. In other words, balance between deviation (prevention) and deformation of the seal element 3 (of PTFE) is made well by fulfillment of the above formulas, influence against the sealing face, namely, lateral movement of the sealing face and angle change in a screw groove (the spiral groove), is small because creep (deviation) vertical to the thickness direction of the seal element 3 is not generated, and excellent sealability can be kept thereby.

In the present invention, not restricted to the above-described embodiments shown in Figures and modifiable to various designs, more than two seal elements 3 and more than two rubber lip portions 22b in FIG. 4 may be provided. Especially, the outer case 7 or the inner case 19 may be the plate-shaped supporting piece 5. And, the sloped wall portion 12 and the inner peripheral end flat wall portion 13, other than straight in cross section, may be arc-shaped having a large radius of curvature. And, the manufacturing method of the plate-shaped supporting piece 5, not restricted to sheeting as shown in Figures, may be cutting or forging. And, the plate-shaped supporting piece 5, not restricted to metal, may be preferably made of plastic.

While preferred embodiments of the present invention have been described in this specification, it is to be understood that the invention is illustrative and not restrictive, because various changes are possible within the spirit and indispensable features.

What is claimed is:

1. A rotation shaft seal comprising a construction in which a plate-shaped supporting piece, supporting a seal element attached with an L-shaped curved portion from a low-pressure side in a cross section cut by a plane including an axis of a rotation shaft, has an axis-orthogonal wall portion, a sloped wall portion of which inner peripheral side inclines with a predetermined inclination angle toward a high-pressure side, and an inner peripheral end flat wall portion, at right angles with the axis, of which dimension in radial direction is approximately same as a thickness dimension of the seal element from an outer side to an inner side, and, an innermost peripheral end face of the inner peripheral end flat wall portion is disposed near the rotation shaft as to form a micro gap between the inner peripheral end flat wall portion and the rotation shaft.

2. The rotation shaft seal as set forth in claim 1, wherein the inclination angle of the sloped wall portion is set to be 20° to 40° and an angle formed by the inner peripheral end flat wall portion and an axis-orthogonal face is set to be −5° to +5°.

3. The rotation shaft seal as set forth in claim 1 or claim 2, wherein the micro gap is set to be 0.1 mm to 0.25 mm on one side.

4. The rotation shaft seal as set forth in claim 1 or claim 2, wherein a relational expression d+1.2T₃≦D≦d+3.0T₃ is fulfilled when the mark D represents an outer diameter dimension of the inner peripheral end flat wall portion, the mark d represents an outer diameter dimension of the rotation shaft, and the mark T₃ represents the thickness dimension of the seal element.

5. The rotation shaft seal as set forth in claim 3, wherein a relational expression d+1.2T₃≦D≦d+3.0T₃ is fulfilled when the mark D represents an outer diameter dimension of the inner peripheral end flat wall portion, the mark d represents an outer diameter dimension of the rotation shaft, and the mark T₃ represents the thickness dimension of the seal element.
